(19) United States
(12) Patent Application Publication
(10) Pub. No.: US 2017/0236313 A1
(43) Pub. Date: Aug. 17, 2017

(54) System for Locating an Individual Within a Historical and Geographical Overlay

(71) Applicant: Rolera LLC, Oswego, IL (US)

(72) Inventors: Adam S. Allgaier, Oswego, IL (US); Jeffrey D. Haddon, Montgomery, IL (US); Kevin Lee Hansen, Boise, ID (US)

(21) Appl. No.: 15/384,284

(22) Filed: Dec. 19, 2016

Related U.S. Application Data
(63) Continuation of application No. PCT/US15/36496, filed on Jun. 18, 2015.
(60) Provisional application No. 62/014,031, filed on Jun. 18, 2014.

(51) Int. Cl. G06T 11/20; G06T 11/60; G06F 17/30

(52) U.S. Cl. CPC G06T 11/206; G06F 17/30979; G06T 11/60

(57) ABSTRACT

A method of placing an individual against a historical backdrop involves comparing biographical data of the individual, such as birth, death, marriage dates, and places of residences with historical figures, events and locations. These historical figures, events, and locations are compared against the individual's biographical data to determine what degree, if any, impact they had or might have had on the individual's life. A historical backdrop is then created that displays the most significant historical figures, events, and locations to the individual and/or the user. This historical backdrop can be displayed, among other ways, as a map, a timeline, a narrative and/or a movie.

### CROSS-REFERENCE TO RELATED APPLICATIONS

This application is a continuation of PCT Application No. PCT/US15/36496 filed on Jun. 18, 2015, entitled “System for Locating an Individual Within a Historical and Geographical Overlay”. The '496 application is further related to and claims priority from U.S. provisional application No. 62/014,031 filed on Jun. 18, 2014, entitled “System for Locating an Individual within a Historical and Geographical Overlay”. The '031 and '496 applications are hereby incorporated by reference in their entireties.

### FIELD OF THE INVENTION

The present invention relates to the use of historical databases including history books, census reports, birth and death records, and other public records along with private genealogical and family history records to place a given individual among significant historical events, people, and locations.

### BACKGROUND OF THE INVENTION

Many individuals enjoy reconstructing their families' genealogies and family histories. A generation ago this often involved initially consulting the family tree found in the family Bible and physically visiting various churches and government agencies to view historical records such as birth, death and marriage certificates. Today various websites have compiled many of these historical records into one place, making genealogy mapping more efficient, complete, and accessible for millions of individuals. Some of these websites even allow individuals to submit a sample of DNA. This sample is then used to indicate where a user's ancestors likely came from. This is useful for users, especially for many orphans and adoptees, who would like to know more about their biological genealogy but do not have a sufficient number of leads.

While mapping out one's family tree can be a meaningful and fulfilling task in its own right; a family tree is much more interesting and informative if one can place his ancestors in a historical context. The user gains a unique and clear understanding of both the potential and actual influences on an individual's life. When this concept is applied to a user's own family tree, the user can make a much more profound connection with his/her ancestors than was previously possible. The user gains an understanding of the sociological forces transmitted through the generations of their forebears that may have influenced them personally or that may be of interest to the user.

The term “place” includes determining that an individual was present in a location during a particular time period and was potentially influenced by activities and events that occurred contemporaneously or earlier and affected individuals living at or around the location. “Placing an individual” involves setting the scene and/or providing a backdrop in a semi-or fully-automated narrative that provides an approximation of what life would have been like for that individual.

While much of this information is already available through history books and historical records, a system that reduces or essentially eliminates the arduous and time-consuming research that would have to be conducted for each individual or ancestor living in a variety of locations or points in history would be greatly appreciated. What is needed is a system that repeatedly and instantaneously applies databases of historical data and matching technology to place individuals and groups of individuals in historical context.

### SUMMARY OF THE INVENTION

The system allows users to understand how a specific individual, often the user's ancestor, was connected to and influenced by his/her historical context. This is accomplished by displaying the individual's identity and location in the midst of significant historical information such as historical events, locations and figures to create a “historical backdrop” during which the individual's life took place.

In one embodiment, a user provides data for an individual they would like to research, either through manual entry, or by uploading a database of information on multiple individuals. The data provided can include, among other things, the date and/or place of birth and/or death of the individual, marriage certificates, school records, military records, and known residences of the individual.

The user-provided data is compared with a database of historical dates, locations and content such as event names, historical figure names, descriptions, and narrative elements. Matches are then identified and prioritized. Prioritization according to a relevance algorithm establishes the results that are most relevant to the individual and the user. Matches can be made according to criteria such as, among other things, those most impactful to the individual, those most recognizable/familiar to the user, and/or those most geographically proximate to the individual.

The most relevant content is then displayed to the user in one or more of a variety of output formats. The output formats can include, among other formats, a timeline, a map, a narrative, and/or a movie. In some embodiments, at least some of these formats can be combined into a unified view that presents them together in a single digital or physical output/product. In at least one embodiment, the various formats are enhanced with a variety of animations that show how historical events, circumstances and impacts change over time. In some embodiments, the individual's various residences can be laid out to illustrate an individual's “lifetime migration”.

In the timeline format the individual's lifespan and/or the date(s) of important life event(s) is shown on a timeline surrounded by significant historical events and/or lifespans of other important historical figures. This format can be automatically-generated by comparing an individual's location(s) and date(s) with a database of historical data. In some embodiments, a user can determine what type of information is included on the timeline.

In the map format an individual's location(s) are shown on a map along with geographic sites or events of historical significance. The historical sites or events can also visually indicate the degree of impact that the historical event may have had on the individual by displaying boundaries, gradients, or other visual devices or representations. In most instances the impact of an historical event or likelihood of interaction with an historical figure is assumed to diminish as distance between the historical site and the individual's location increases. There are cases, however, in which an event, such as the start of World War II in Europe, was impactful even for individuals living in the U.S. The areas/boundaries of impact can change with the time scale selected for the map. For the purpose of generating the individual's contextual map, location can be determined and defined in a variety of ways including, among other ways, the location of a significant life event such as birth, christening or death, the residence of an individual at a point in time or over a period of time, and a series of residences over time.

The map can be displayed with historically accurate borders and location names that existed at the time of the individual's life. In some embodiments, a satellite map can be overlaid with historical maps. In other embodiments, it is the historical maps which are overlaid with satellite images.

In the narrative format, a narrative can be automatically assembled from a database of content that describes the general life circumstances that existed or that were likely experienced by the individual given the individuals location(s) and/or date(s). Material that can be included in the narrative include, among other things, living conditions, education, employment, food and nutrition, shelter, child birth, death, religion, historical events, and proximity to historical figures and landmarks. The depth and detail of the narrative can be enhanced by additional information about the individual that can be provided by the user such as gender, socioeconomic class, occupation, or obtained from historical records.

The narrative can also contain statistics about the individual's environment and life such as: world, national and/or local population during the individual's life. It can also include the individual's known ancestors and descendants and their known locations and lifespans.

The movie format is similar to the narrative format. The movie can be automatically generated from content housed in a database after the individual's location(s) and date(s) are taken into account. In some embodiments the individual's socioeconomic class, occupation or other similar details are also taken into account when generating the movie.

In some embodiments, a user can determine what type of historical data should be displayed in the formats by choosing categories including, but not limited to, politics, medicine, arts and culture, commerce and industry, and religion.

Once the combined data is presented to the user in a default view, the user is able to interact with and customize the results in a variety of ways including, among others: adjusting the time scale to see a broader or narrower time span; drilling into the historical content and narratives for more detail and an explanation of its impact (either known or probable) on the individual; palming and zooming on the map to see different details and regions; controlling animations; selecting other individuals to investigate.

In at least one embodiment, as the user interacts with and modifies the interface settings, the relevance of the data continuously recalculates according to a relevance algorithm and the user's preference settings resulting in real-time changes to the content that is presented to the user.

The more data on a given individual that a user can provide, either from personal knowledge or through genealogical or other databases, the more specific and tailored the resulting historical background. For example, if a user knows, either from family records, or the system finds out via historical records, that a given individual who lived in Chicago was stationed in Italy during World War II, that individual's historical summary will include famous individuals living in or near Italy at the time, and historical events taking place in and around Italy during the time of that individual's deployment as well as events taking place in Chicago.

In some embodiments, the user can determine how wide a search to conduct in determining the historical background. For example, the default can be set at worldwide, so that historical events that took place during or around the individual's life will be included in his or her historical backdrop. In another embodiment, the search radius can be narrowed to a various number of ranges including, among other things: the nation the individual lived in, the state the individual lived in, the city the individual lived in, and the typical range an individual living in that time period would be expected to travel (for example 100 miles). The individual's religion can also be used to determine which events are shown. For example, if the individual is Roman Catholic, his historical backdrop can include information such as changes in the Roman Catholic Church and who was pope.

In at least one embodiment, a relocation path of the individual can be mapped on the geographical map. In one form, the relocation map takes into account the birth and death locations of the individual and draws a path connecting these two locations. In more elaborate examples, an individual's residences can be included to form a more complete relocation path. This information can be obtained either directly from the user, or from historical records including, among other records, birth, death, marriage, property, work, tax, and educational records. This relocation path, and its corresponding timeframe (usually the lifespan of the individual assuming this is known) allows for a more customized historical background.

In some embodiments, the gender of the individual can be taken into account in generating the historical background. For example, the historical background section for a woman living in the United States during the 1910s-1920s can include a section discussing the impact of the 19^{th} Amendment and woman's suffrage. The historical summary can also include gender specific information such as fashion and typical jobs.

In one example, the race of the individual can be taken into account in generating the historical background. For example, the historical background of an African American individual living in the United States during the early to mid-1900's can include information pertaining to African American discrimination.

While the preceding paragraphs discuss using the system to map out the historical background of family ancestors, it should be noted that this system can be used for unrelated individuals as well. For example, in one embodiment history teachers can map out famous historical figures to illustrate to their class what other historical events were taking place across the world, giving their students a better understanding of the time period. Use of the system can also be used by historians to recognize historical connections they had not considered such as the fact that two famous individuals were classmates at a local school or that they shared a childhood hometown.

In some embodiments, the system is a stand-alone web-based or client-based product. In other embodiments, the system takes the form of a web browser plugin that is capable of enhancing the data available from other websites, including current genealogy sites such as Ancestry.com. The system could also act as data enhancement to other websites and products that would be licensed to those companies.

### BRIEF DESCRIPTION OF THE DRAWINGS

FIG. 1 is a schematic for a system for locating an individual within a historical and geographic overlay.

FIG. 2 is a screenshot of a start screen for adding an individual.

FIG. 3 is a screenshot of the start screen for adding a famous individual.

FIG. 4 is a screenshot of a timeline format screen.

FIG. 5 is a screenshot of unified format screen which includes as timeline pane, map pane, and narrative pane.

FIG. 6 is a screenshot of the unified format screen of FIG. 4 in which a user is exploring the various events indicated on the timeline pane and map pan in greater detail.

FIG. 7 is a screenshot of a vertical lifespan timeline screen.

### DETAILED DESCRIPTION OF PREFERRED EMBODIMENT(S)

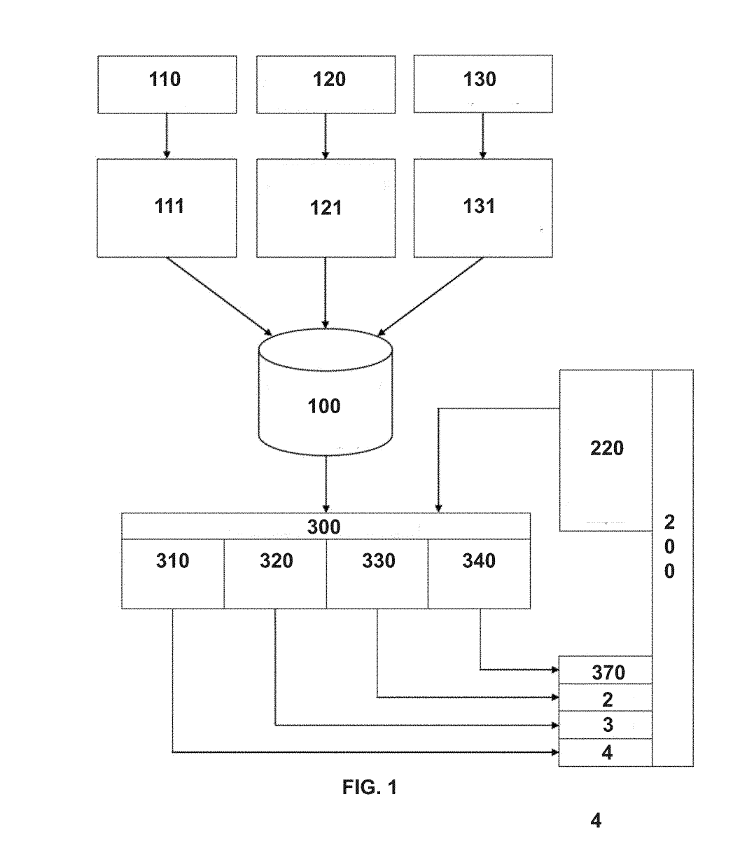

Turning first to FIG. 1, Historical Database 100 is populated with Location Data 110, Events and Individuals Data 120, and Life Dimensions Data 130 from various sources.

Location Data 110 can include, among other things, information about countries, regions, cities, and landmarks. Location Data 110 can be tagged with date and location-specific information such as: geocoding, physical descriptions, population information, industries in the area, and demographic information in Location Tagging Stage 111.

Events and Individuals Data 120 can include, among other things, information about wars, disasters, inventions, authors, and rulers. Events and Individuals Data 120 can be further tagged to indicate their relevance such as the personal impact of the events on particular individuals and the familiarity of the events and individuals to modern users in Events and Individuals Tagging Stage 121. Events and Individuals Tagging Stage 121 can be automated by using information inputted by users.

Life Dimensions Data 130 can include, among other things, information about fashion, transportation, education and medicine. This information can be tagged with date and location-specific information such as geocoding in Life Dimensions Tagging Stage 131. Narrative descriptions based on various factors such as gender, race, and social economic class can also be generated in life dimensions tagging stage 131.

A user using User Interface 200 can input Personal Data 220 via manual entry, database upload, or an application programming interface (API). Personal Data 220 can include information about a given individual such as his or her birth date, place of birth, occupation, relocation information including place and date, and date and place of death.

Personal Data 220 is combined with Historical Database 100 in Matching and Relevance Engine 300. Matching and Relevance Engine 300 can include various parts including Map Rendering Engine 310, Narrative Rendering Engine 320, Timeline Rendering Engine 330, and Movie Rendering Engine 340.

Map Rendering Engine 310 is used to create Map Pane 4; Narrative Rendering Engine 320 is used to create Narrative Pane 3; Timeline Rendering Engine 330 is used to create Timeline Pane 2; Movie Rendering Engine 340 can be used to animate Narrative Pane 3, Map Pane 4, and/or Timeline Pane 2 by creating Movie 370.

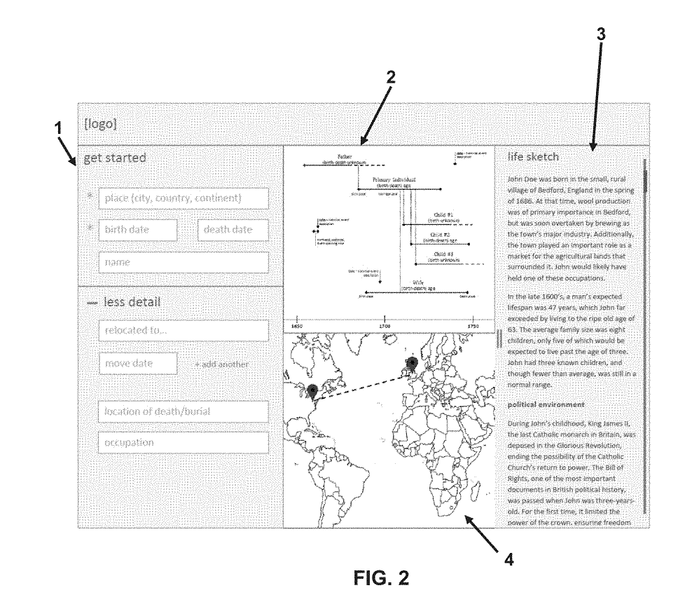

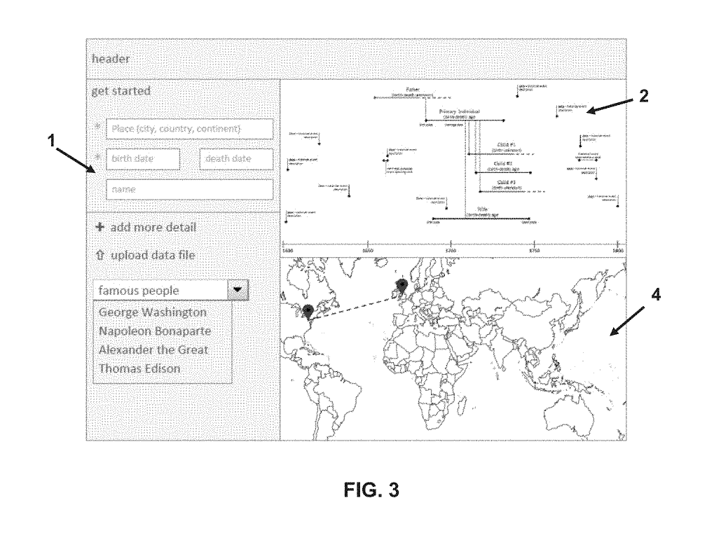

FIG. 2 and FIG. 3 are examples of startup screens for an application configured to create a historical background for an individual. The startup screen of FIG. 2 contains Data Pane 1, Timeline Pane 2, Narrative Pane 3, and Map Pane 4. Data entered into Data Pane 1 can include, among other things, the birth and death dates of the individual, the name of the individual, place(s) the individual lived and related dates of residence, the individual's gender, and occupation of the individual.

Timeline Pane 2 can include, among other things, the lifespan of the individual and known ancestors and descendants, the lifespans of historical figures, the dates of historical events, and important milestones in the individual's life such as getting married. The historical figures and events can be chosen from a database, and can be limited to those events and figures that were located near the individual and/or either had or likely had a direct impact on the individual.

Narrative Pane 3 includes a customized narrative for the individual generated from a database of historical content. The narrative becomes more customized as the user adds more data into Data Pane 1.

Map Pane 4 shows the location of historical events that occurred during and around the individual's lifespan along with the location of the individual. Map Pane 4 can also include a relocation path that illustrates the movement of the individual throughout his or her life.

In some embodiments, once a user begins entering data in data pane 1, Timeline Pane 2, Narrative Pane 3, and Map Pane 4, begin updating to show more relevant information. In other embodiments, the user can manually indicate that he is done entering data into Data Pane 1 and that Timeline Pane 2, Narrative Pane 3, and Map Pane 4 should update.

FIG. 3 is similar to FIG. 2, except that instead of the user entering data about a particular individual into Data Pane 1, the user selects a famous individual from a list of pre-entered individuals. This allows the user to view information in Timeline Pane 2 and Map Pane 4 that is relevant to the famous individual's life. This embodiment is useful in helping student's place historical figures in context with what was occurring in their life and the world in general.

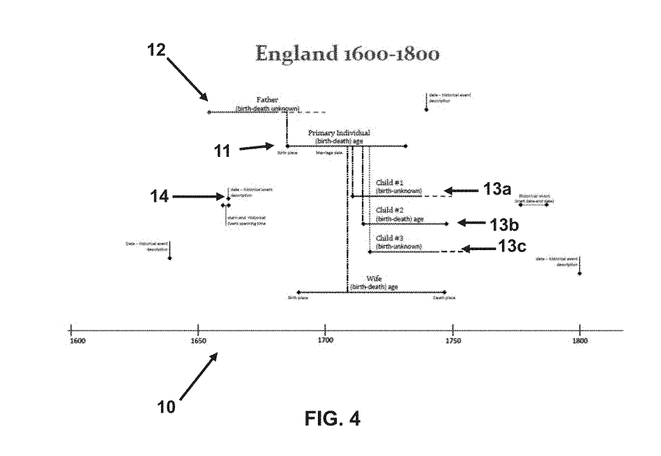

FIG. 4 in a screenshot of the historical content being displayed in timeline format. Timeline 10 covers a variable span of time which includes Lifespan of the Individual 11. It can also include Lifespans of the Individual's Direct Ancestor 12 and/or Lifespans of the Individual's Direct Descendant 13a-c. FIG. 2 also shows Historical Content 14 that, in at least some embodiments, would have been relevant to the individual.

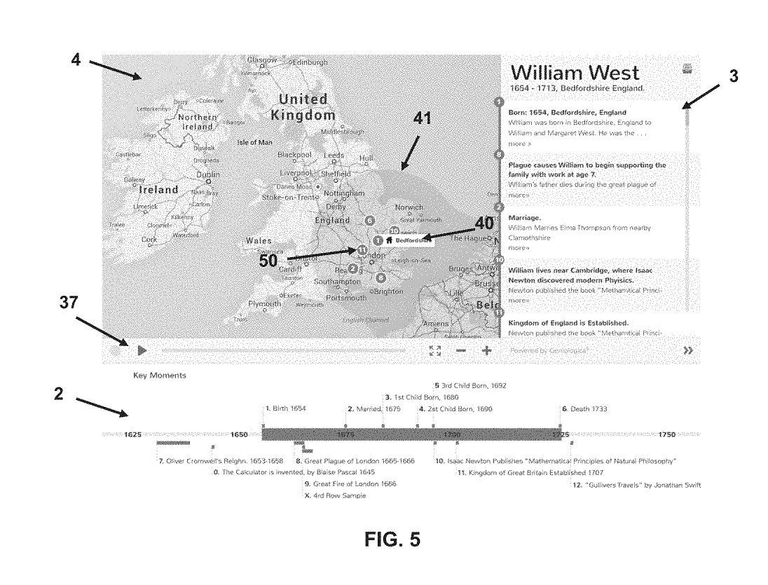

FIG. 5 shows a unified view of the historical background. It contains Timeline Pane 2, Narrative Pane 3, and Map Pane 4. Timeline Pane 2 includes both the individual's lifespan and historical events that would be relevant to the individual. It also includes important events in the individual's life, such as his marriage and the birth of his children.

Narrative Pane 3 shows a basic narrative of the individual's life, splicing together both personal events in the individual's life with historical events and people that likely had an impact on his life.

Map Pane 4 includes a map that shows where both historical events and personal events in the individual's life took place. In one embodiment, Map Pane 4 can be animated so that Earlier Historical Marker 40 pops up before Later Historical Marker 50 which takes place after the event associated with Historical Marker 40. Map Pane 4 can also include a relocation path for the individual. In some embodiments, clicking on Earlier Historical Marker 40 highlights Event Impact Boundary 41 on the map. In other embodiments, Event Impact Boundary 41 is shown by default. The animation can be controlled by Animation Control 37.

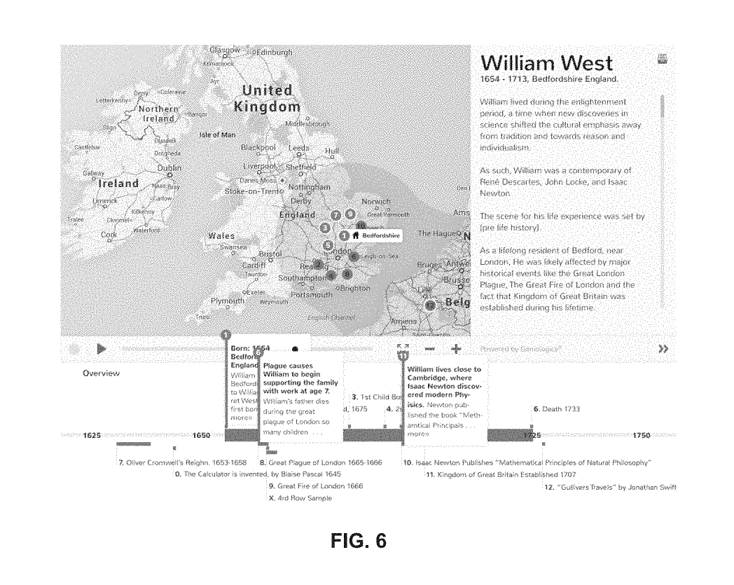

FIG. 6 is a screenshot of the unified view in FIG. 5 where the user has decided to delve deeper into the historical events. Descriptions can be presented that provide additional detail on the event or historical figure and how that event or figure may have impacted the individual.

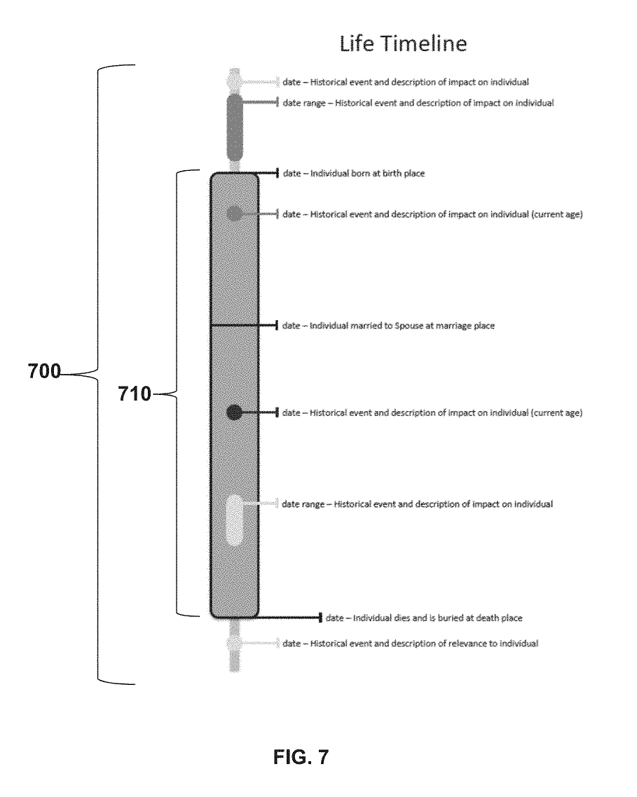

FIG. 7 is a screenshot of Timeline 700 that can be used in connection with or at an alternative to Timeline Pane 2. An individual's lifespan can be indicated by Lifespan Graphic 710. Historical events can be color coded to indicate their relevant impact on the individual. In one embodiment, low impact events could be colored yellow, medium impact events could be colored orange, and high impact events could be colored red. In some embodiments other graphical means, such as the size of the dot can be used to represent the impact on the individual.

While particular elements, embodiments and applications of the present invention have been shown and described, it will be understood, that the invention is not limited thereto since modifications can be made without departing from the scope of the present disclosure, particularly in light of the foregoing teachings.

What is claimed is:

1. A method for placing an individual in a historical backdrop, the method comprising:
(a) receiving at least one biographical datum associated with said individual;
(b) employing said at least one biographical datum to search a plurality of historical databases;
(c) generating said historical backdrop for said individual.

2. The method of claim 1 wherein said at least one biographical datum is selected from the group consisting of said individual's date of birth, date of death, place of residence, religion, at least one tax record, at least one marriage certificate, and at least one property deed.

3. The method of claim 1 wherein said historical backdrop is displayed on a timeline.

4. The method of claim 3 wherein said timeline is customizable by a user.

5. The method of claim 3 wherein said timeline comprises an animation.

6. The method of claim 1 wherein said historical backdrop is displayed on a geographical map.

7. The method of claim 6 wherein said map is customizable by a user.

8. The method of claim 6 wherein said map comprises an animation.

9. The method of claim 1 wherein said historical backdrop is displayed as a narrative.

10. The method of claim 1 wherein said historical backdrop is displayed as a movie.

11. A system for displaying an individual's presence in a historical backdrop, the system comprising:
(a) a device for storing at least one biographical datum associated with said individual;
(b) a plurality of historical databases accessible to said device, said historical databases searchable using said at least one biographical datum;
(c) a display for depicting said historical backdrop.

12. The system of claim 11 wherein said at least one biographical datum is selected from the group consisting of said individual's date of birth, date of death, place of residence, religion, at least one tax record, at least one marriage certificate, and at least one property deed.

13. The system of claim 11 wherein said historical backdrop is displayed on a timeline.

14. The system of claim 13 wherein said timeline is customizable by a user.

15. The system of claim 13 wherein said timeline comprises an animation.

16. The system of claim 11 wherein said historical backdrop is displayed on a geographical map.

17. The system of claim 16 wherein said map is customizable by a user.

18. The system of claim 16 wherein said map comprises an animation.

19. The system of claim 11 wherein said historical backdrop is displayed as a narrative.

20. The system of claim 11 wherein said historical backdrop is displayed as a movie.
